(19) United States
(12) Patent Application Publication
(10) Pub. No.: US 2001/0039545 A1
(43) Pub. Date: Nov. 8, 2001

(54) Method of managing an electronic file and a computer program product

(76) Inventor: Hidekazu Nishizawa, Machida-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/811,517

(22) Filed: Mar. 20, 2001

(30) Foreign Application Priority Data
Apr. 27, 2000 (JP) 2000-128219

(51) Int. Cl. G06F 17/60; G06F 17/30; H04L 9/00

(52) U.S. Cl. 707/9; 713/156; 713/175; 707/200; 705/51

(57) ABSTRACT

The present invention discloses an art to enable users to easily confirm the electronic file is authorized file. More particularly, a summarized value for the electronic file is retained in a document history management system and the electronic file is retained in a document management system upon input of the electronic file for authorizing the original entity. Under the condition, conformity or non-conformity between the summarized value obtained from the electronic file in the document management system and the corresponding summarized value in the document history management system is determined upon input of confirmation request for verifying the electronic file is authorized file. When the result of the determination indicates the conformity of the two summarized values, a certificate describing that the electronic file is not interpolated and that the electronic file is the latest is issued.

### CROSS-REFERENCE TO RELATED APPLICATIONS

This application is based upon and claims the benefit of priority from the prior Japanese Patent Application No. 2000-128219, filed Apr. 27, 2000, the entire contents of which are incorporated herein by reference.

### BACKGROUND OF THE INVENTION

The present invention relates to a method of managing an electronic file to be used for a system for managing electronic files and for authorizing the electronic file is authorized file and a computer program product.

Along with general tendency of shifting to office automation, a need to store data in a form of electronically prepared documents, hereinafter called as electronic files, and to establish an art to safely storage and manage an electronic file consisting of an electronically prepared document have been enhanced.

For converting conventional documents written on papers, hereinafter called as paper documents, to electronically prepared documents and storing as electronic files, it is required to fill five requirements for authorizing the electronic file is authorized file, those which are prevention of interpolation, writer's authentication, access control, back-up and document history management.

In particular, during documents management, electronic files are always revised and old documents should be promptly thrown out. Therefore, for the documents management, in addition to a requirement of interpolation prevention for authorizing that no interpolation is given in an electronic file by means of giving an electronic signature, a requirement of document history management for managing the historical revision of an electronic file and for authorizing that the original (authorized file) is the latest is considered as so important.

FIG. 1 is a schematic diagram schematically showing the conventional authorized original document management system and the peripheral constitutions adapted to the requirements described above. The authorized original document management system 1 is connected to a user terminal (PC; Personal computer) 3 via network 2, and has a function to perform authorization and confirmation of the original entity of a registered electronic file 4 registered by the terminal user 3 corresponding to a request from the user terminal 3. “The original entity” means that “the electronic file is authorized file”.

The authorized original document management system 1 is a computer server system having complex software structure of both original entity confirming function, including document signer authorizing function, access controlling function, back-up function, interpolation preventing function and document history management function, and basic document managing function, including access controlling function, back-up function, inspection function and searching function.

However, access controlling function, back-up function and document history management function included in the function for filling the original entity are also included in the basic document managing function.

In the authorized original document management system 1, the system authorizes a fact that no interpolation is contained in the electronic file 4 registered by user terminal 3 by employing cryptography technique and manages the operational history for the electronic file 4, thereby authorizing the original entity of the electronic file 4.

When confirmation on the original entity is required, an user terminal 3 asks the authorized original documents management system 1 by own operation whether a desired electronic file is the original or not. Upon access of the user terminal, the authorized original document management system 1 sends a reply to the user terminal with a message, for example, “This is the original”. The original entity of the electronic file 4 can be thereby confirmed as described above.

However, by using the authorized original document management system 1 as described above, it is difficult for a user terminal to confirm the original entity, though the original entity can be confirmed by the system 1 itself. Because, architecture for authorizing the original entity differs between respective authorized original document management systems and the administration in the system 1 is not clear for the user. In addition, the authorized original document management system 1 has complex structure as it is connected to the document management function. Furthermore, in many cases, each vendor for an authorized original document management system 1 has not disclosed the administration procedure.

Consequently, when an user terminal enquired if an electronic file 4 is the original or not, the user terminal is forced to believe the replied message, such as “This is the original”, which is received by the user terminal 3 from the authorized original document management system 1, even though the ground of the replied message is not clear for the user terminal.

### BRIEF SUMMARY OF THE INVENTION

It is an object of the present invention to provide a method of managing an electronic file by which a user can easily confirm the original entity of an electronic file and a computer program product.

The subject matter of the present invention is directed to issue information for authorizing the electronic file is authorized file and to enable a user to confirm the original entity of the information. “The original entity” means that “the electronic file is authorized file”. In this sense, it is not essential but preferable to prepare the information for authorizing the original entity in a form of an easily detectable document in view of facilitating the confirmation of the original entity. In the following explanation, an example showing the information to authorize the original entity with a document is described.

In view of the easily-detectable form as described above, the present invention is directed to two requirements, which are prevention of interpolation and document history management, among the five requirements for authorizing the original entity. More definitely, in the present invention, the system stores in the document history table a summarized value for an electronic file, for example, hash value for preventing interpolation, and operational details for the document history management.

By storing such requirements, preparation of an easily-detectable document form, for example, XML documents, containing a summarized value for an original electronic file and the operational history details can be facilitated. This document (hereinafter also called “certificate”) is prepared with attachment of an electronic signature or in a form containing an electronic signature.

The certificate and the signature show the ground for the original entity, such as the summarized value and the operational details in XML form, therefore, display and confirmation of such information are enabled if standard Web browser corresponding to XML and electronic signatures is used in the system. (According to the conventional technology, confirmation of the ground for the original entity was not impossible but it was required to operate a dedicated application after understanding a complex document management system. Thus, ordinary users have been forced to believe a replied message without a firm ground.)

In the present invention, the certificate may be managed by providing time limitation, and the renewal of the original documents (authorized electronic files) before the time limitation may be ruled out. Such management of the time limitation for the certificate is preferable in view of assuring conformity between the authorizing documents and the original documents. If required, the time limitation may be written on the certificate.

Further, in the present invention, the original entity authorizing function is realized by separating it from the document management system. For example, in the authorized original document management system according to the present invention, the interpolation preventing function and the document history managing function, both of which are the main function for authorizing the original entity, are constituted as the independent document history management system to facilitate connection to a conventional document management system, and an user interface for utilizing the interpolation preventing function and the document history managing function is concretized for the users. However, such constitution wherein the original entity authorizing function is separated from the document management system is not the essential requirement and it may be deleted if the system can issue the authorizing documents described above.

Based on the subject matter of the present invention, the following means are provided for carrying out the present invention.

The present invention is directed to a method of managing an electronic file, which contains a step of issuing a certificate describing that the electronic file is not interpolated and that the electronic file is the latest one corresponding to an input of a request for verifying the electronic file is authorized file and a step to output the issued certificate.

In the certificate, operational history on an electronic file corresponding to the request for verifying may be included. And, the description about a fact that the electronic file has not been interpolated may be expressed as a description of the summarized value for the electronic file.

Further, the present invention may contain a step of determining if the certificate being issued is within the time limitation or not when an input writing request for rewriting the electronic file has come and a step of restricting to perform the writing operation when the determined result indicated that the input is made within the time limitation.

The system of the present invention is not limited by the manner to use the certificate as the system is only aiming at authorizing the electronic file is authorized file. For example, the present invention may contain a step of producing the first information for indicating a fact that the electronic file has not been interpolated upon an input of request for verifying the electronic file is authorized file, the second information indicating a fact that the electronic file is the latest one, and the third information indicating the time limitation for both of the first information and the second information, a step of outputting the first information through the third information produced in the step above, and a step of determining the input writing request for rewriting the electronic file is within the time limitation for the first information and the second information based on the third information and to restrict to perform the writing operation when the determined result indicated that the input is made within the time limitation.

Again, the present invention is directed to a method of managing an electronic file for authorizing the electronic file is authorized file, wherein a document management system for managing an electronic file and a document history management system for managing the history of an electronic file in connection with the document managing system, and the method contains a step of determining a summarized value for the input electronic file upon an input of the electronic file for authorizing the original entity into the document management system and retain the obtained summarized value in the document management system, a step of retaining the input electronic file in the document management system, a step of determining the conformity or nonconformity between the summarized value newly determined for the electronic file retained in the document management system and the corresponding summarized value retained in the document history management system upon request for verifying the electronic file is authorized file, and a step of authorizing the original entity of the electronic file when two summarized values are found to be identical from the results obtained in the determination process described above.

In the step of retaining the summarized value in the document history management system, a step of retaining a label for the new registration, the summarized value and ID for the electronic file and then to return the ID for the electronic file to the document management file upon receipt of the summarized value from the document management system may be also included.

Also, in the step of authorizing the original entity, a step of issuing a certificate for authorizing a fact that the electronic file is the authorized file may be included. For example, a step of outputting a certificate containing a summarized value corresponding to ID and operational history for the electronic file corresponding to the ID when receiving the ID from the document history management system may be included in the authorizing step.

Further, a check-out step of preventing others from simultaneously renewing an electronic file by while the electronic file is renewed, a check-in step of retaining the revised electronic file in the document management system while retaining the summarized value of the revised electronic file in the document history management system when the revised electronic file is prepared following to the check-out step described above, a step of determining the conformity or non-conformity between the summarized value newly obtained from the revised electronic file retained in the document management system and the summarized value corresponding to the revised electronic file retained in the document history management system upon an input of request for verifying the electronic file is authorized file following to the check-in step described above, and a step of authorizing the original entity of the revised electronic file when the two summarized values are found to be identical from the results obtained in the determination process may be added to the step of authorizing the original entity described above.

In the check-out step described above, a step of register a label for the check-out and new ID for the check-out and then return the new ID to the document management system when receiving the ID of the electronic file being the object of check-out may be included.

Again, in the check-out step described above, a step of determining if the electronic file is within the time limitation for the issued certificate when receiving the ID from the document management system and a step of restricting to perform the check-out step when the electronic file is within the time limitation may be also included.

Whereas, in the check-in step described above, a step of registering a label for the check-in and a new ID for the obtained summarized value and the check-in when receiving the ID for the check-in and the summarized value for the revised electronic file and then to return the new ID for the check-in to the document management system may be included.

However, in the check-out step and the check-in step, the registration of the process details is not required by the identical input, and the designation for the “check-out” and “check-in” may be appropriately changed or omitted.

Also, for receiving each of the ID and the summarized value described above, a step of receiving a document data prepared with containing the ID and the summarized value in accordance with a pre-determined form with standard markup language may be included.

Similarly, for the reply to the ID and the certificate described above, a step of preparing a document data containing the ID and the certificate in accordance with a pre-determined form using a standard markup language and to return the document data may be included.

In addition, the invention described above may be carried out by installing a program from a storage medium capable of reading-out from a computer in which a program for effectuating the respective steps described above is stored. Further, the program described above may be formed as any of the following three types.

(1) A program for a computer equipped with the authorized original document management system consisting of a document management system and a document history management system to effectuate each functions.

(2) A program for a computer equipped with the document management system contained in the authorized original document management system to effectuate each functions.

(3) A program for a computer equipped with the document history management system contained in the authorized original document management system to effectuate each functions.

The program may be expressed as either “A computer program product stored on a computer-readable medium” or “Program stored in a computer-readable storage medium”.

By providing the means as described above, the system of the present invention issues an certificate describing that the electronic file has not been interpolated and that the electronic file is the latest and then outputs the certificate having been issued. In this manner, users can easily confirm the original entity of the electronic file.

Further, the system of the present invention uses a document management system for managing electronic files and a document history management system being connected to the document management system to manage the history of the electronic files, and the system determines the summarized value upon an input of an electronic file being objected for authorization of original entity into the document management system, retains the summarized value determined in the document history management system and retains the input electronic file in the document management system.

In such condition, when request for verifying the electronic file as authorized file is input, the system determines conformity or non-conformity between the summarized value newly obtained from the electronic file in the document management system and the corresponding summarized value retained in the document history management system and then authorizes the electronic file as authorized file if the two summarized values are found to be identical as the result of the determination.

In this manner, users can easily confirm the electronic file as authorized file.

Here, the operation of the system is facilitated and assured by retaining a label for the new registration, the summarized value and the ID for the electronic file in the document history management system upon receipt of the summarized value from the document management system and by simultaneously returning the ID to the document management system.

Also, at authorizing the electronic file as authorized file, the confirmation will be further facilitated by issuing a certificate for authorizing the original entity of the electronic file. More definitely, a certificate containing the summarized value corresponding to the ID and the operational history for the electronic file corresponding to the ID is issued when the ID is received from the document history management system.

The electronic file being managed as described above may be prepared into one capable of preparing the revised file in the check-out step for prevent others from simultaneously renewing an electronic file while the electronic file is renewed.

Also, when the revised electronic file is prepared following to the check-out step, the revised electronic file may be processed in the check-in step to retain the revised electronic file in the document management system while retaining the summarized value obtained from the revised electronic file in the document history management system, thereby managing the revised electronic file according to the similar manner described above.

For example, following to-the check-in step, when a request for verifying the electronic file as authorized file is input, authorization as regard to the original entity for the revised electronic file may be accomplished by determining the conformity or non-conformity between the summarized value newly determined for the revised electronic file in the document management system and the summarized value being retained in the document history management system corresponding to the revised electronic file and by checking if the two summarized values by the determination are identical or not.

In the check-out step, the operation may be facilitated and assured by registering a label for the check-out and a new ID for the check-out when receiving the ID for the electronic file engaged to the check-out from the document management system and returning the ID to the document management system.

Further, in the check-out step, the conformity between the original and the certificate may be easily assured by determining if the objective file is within a certain time limitation or not when receiving the ID from the document management system and by restricting to perform the check-out step if the file is still within the time limitation, for example.

Whereas, in the check-in step, the operation of the system may be facilitated and assured by registering a label for the check-in, a summarized value and a new ID for the check-in when receiving the ID for the check-in and the summarized value for the revised electronic file from the document management system and by then returning the new ID for the check-in to the document management system.

Whereas, by means of preparing a document data with including the ID and the summarized value in accordance with the pre-determined form using standard markup language at receiving each of the ID and the summarized value described above by user's operation, they can easily understand about the authorization for the electronic file as authorized file even though they are not well accustomed to the authorized original document management system.

Further, by means of preparing a document data with including the ID and the certificate in accordance with the pre-determined form using a standard markup language at returning each of the ID and the certificate described above to the users and then returning the document data to the users, they can easily understand about the authorization for the electronic file as authorized file even though they are not well accustomed to the authorized original document management system.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a schematic diagram showing a conventional authorized original document management system and the peripheral constitution.

FIG. 2 is a schematic diagram showing the authorized original document management system according to the first embodiment and the peripheral constitution.

FIG. 3 is a block diagram showing a definite constitution for the authorized original document management system according to the first embodiment.

FIG. 4 is a flow chart for explaining the operation at the new registration in the system according to the first embodiment.

FIG. 5 is a schematic diagram for explaining the XML document described in the first embodiment.

FIG. 6 is a schematic diagram for explaining the XML document described in the first embodiment.

FIG. 7 is a flow chart illustrating the operation at confirming the original entity described in the first embodiment.

FIG. 8 is a schematic diagram for explaining the XML document described in the first embodiment.

FIG. 9 is a schematic diagram for explaining the certificate prepared in a XML document form described in the first embodiment.

FIG. 10 is a block diagram showing the constitution of the authorized original document management system according to the second embodiment.

FIG. 11 is a schematic diagram for explaining the operation at the check-out described in the second embodiment.

FIGS. 12A and 12B are flow charts for explaining the operation at the check-out described in the second embodiment.

FIG. 13 is a schematic diagram for explaining the XML document described in the second embodiment.

FIG. 14 is a schematic diagram for explaining the XML document described in the second embodiment.

FIG. 15 is a schematic diagram for explaining the XML document described in the second embodiment.

FIG. 16 is a schematic diagram for explaining the XML document described in the second embodiment.

FIG. 17 is a schematic diagram for explaining the operation at the check-in described in the second embodiment.

FIGS. 18A and 18B are flow charts for explaining the operation at the check-in described in the second embodiment.

FIG. 19 is a schematic diagram for explaining the XML document described in the second embodiment.

FIG. 20 is a schematic diagram for explaining the XML document described in the second embodiment.

FIG. 21 is a schematic diagram for explaining the XML document described in the second embodiment.

FIG. 22 is a schematic diagram for explaining the operation at confirming the original entity described in the second embodiment.

FIG. 23 is a flow chart for explaining the operation at confirming the original entity described in the second embodiment.

FIGS. 24A and 24B are schematic diagram for explaining the first half of the certificate prepared in XML document form described in the second embodiment, respectively.

FIG. 25 is a schematic diagram for explaining the second half of the certificate prepared in XML document form described in the second embodiment.

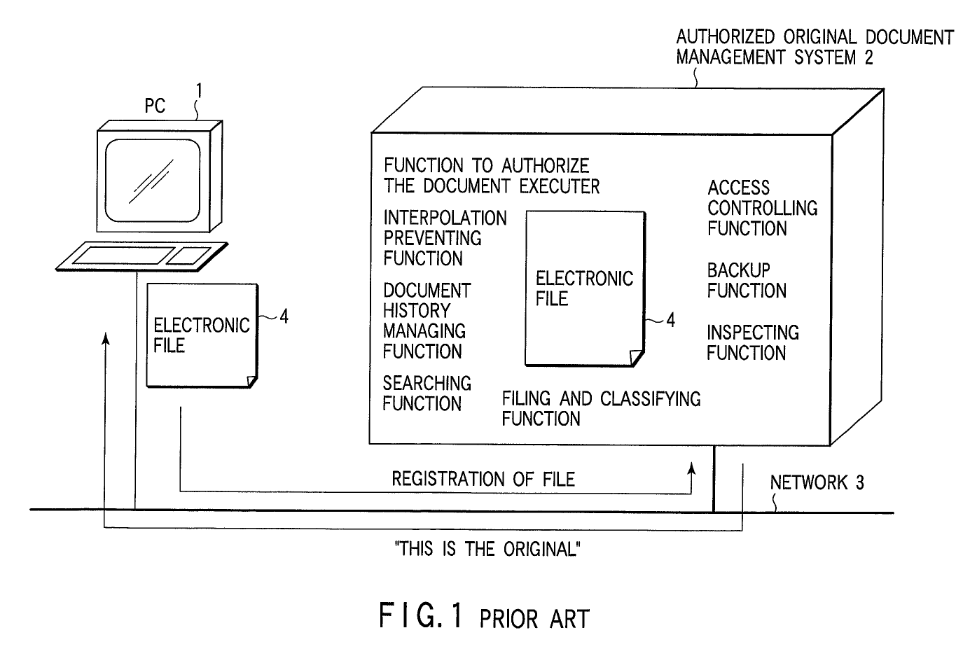

### DETAILED DESCRIPTION OF THE INVENTION

Embodiments for carrying out the present invention will now be described with reference to drawings.

(First Embodiment)

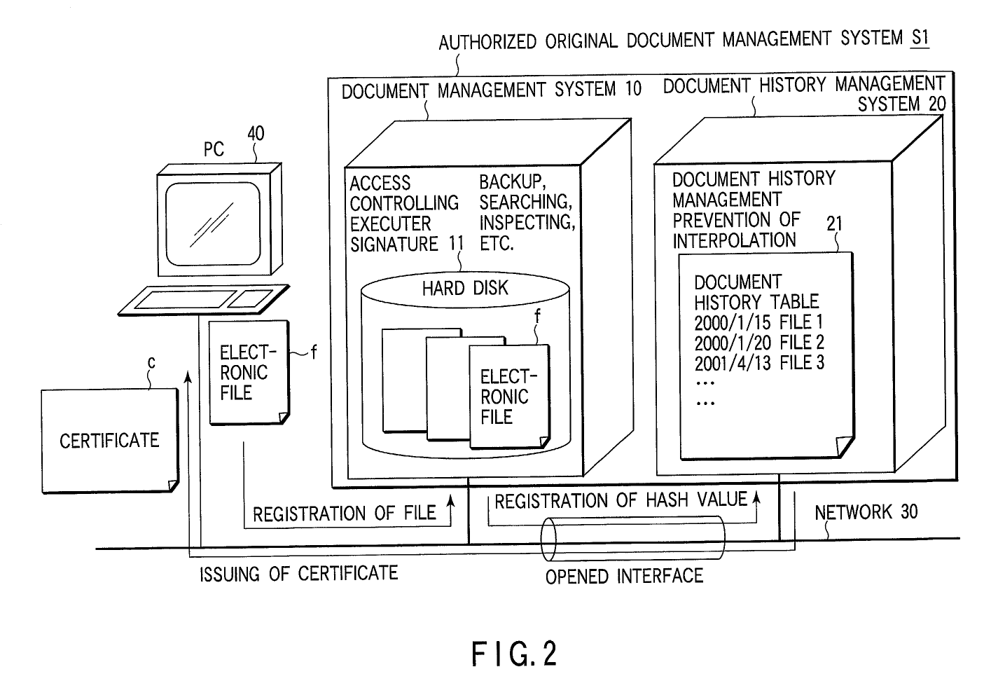

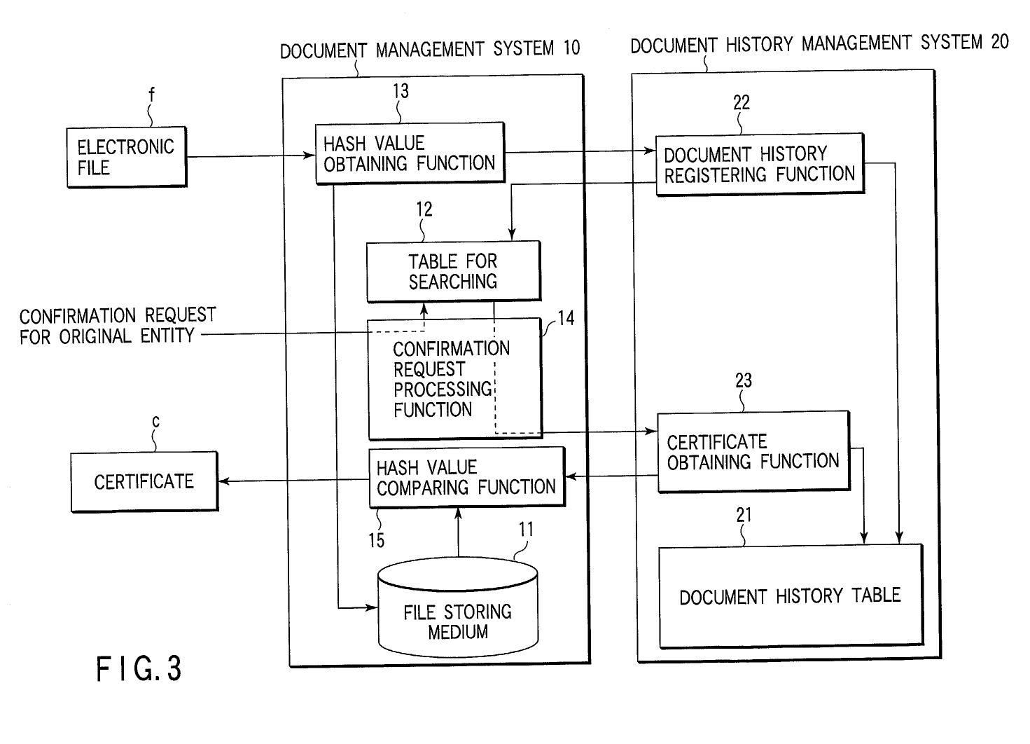

FIG. 2 is a schematic diagram showing the authorized original document management system according to the first embodiment and the peripheral constitution thereof, and FIG. 3 is a block diagram showing the definite constitution of said authorized original document management system. In the authorized original document management system S1, document management system 10 and document history management system 20 are connected each other via network 30, and each of the systems 10 and 20 are connected to an user terminal 40 via network 30.

In this embodiment, the document management system 10 is provided with file storing medium 11, table for search 12, hash value obtaining function 13, confirmation request processing function 14 and hash value comparing function 15 in addition to known functions, such as access controlling function, back-up function, and document signer authorizing function (known electronic signature function). The functions 13 through 15 can be operated by installing a program for effectuating those functions from the storage medium.

The file storing medium 11 is a storage part whereto electronic files, f1, f2, etc., which have been sent from an user terminal 40, are stored in readable state by the hash value obtaining function 13, and a hard disk is used as the file storing medium in this embodiment.

The table for search 12 is for performing functions for managing documents, such as searching, ordering and classifying, and more definitely, when the document management system 10 received a set of information including different ID (identification) information on respective electronic file f and respective revised electronic file thereof, a file name for an electronic file designated by the ID, and URL (Uniform Resource Locator) as general information showing file location from the document history management system 20, said ID and URL are written and stored in the table for search by the document management system 10, which are readable by the confirmation request processing means 14.

The hash value obtaining function 13 has the following functions (13a) through (13c).

(13a) A function to obtain a hash value (a summarized value for an electronic file f) for an electronic file f registered by a user terminal 40 by using a hash function (unidirectional hash function or less collision hash function).

(13b) A function to store an electronic file f into the file storage medium 11 following to the obtaining of a hash value.

(13c) A function to transmit a hash value as “New registration” in XML (extensible Markup Language) document form together with other file information (URL of an electronic file f) and a label for operation to an electronic file (operation attribute) to the document history management system 20.

The hash value obtaining function 13 is not directed to only the hash function and may be modified into a constitution using a system for determining the summarized value instead of hash function, if such system for determining the summarized value for an electronic file f is available.

The confirmation request processing function 14 has the following functions (14a) and (14b).

(14a) A function to search the table for search 12 based on the designated electronic file f upon confirmation request for the original entity from an user terminal 40 and to obtain ID for the designated electronic file. Here, “the confirmation request for the original entity” means that “the request for verifying the file is authorized file”.

(14b) A function to prepare a XML document containing the operation attribute, “Issuing Authorized Original” by using the obtained ID and to transmit the obtained XML document to the document history management system 20.

The hash value comparing function 15 has the following functions (15a) through (15c).

(15a) A function to read-out an electronic file f corresponding to ID in an certificate C from the file storage medium 11 and to determine the identity of the summarized values between the hash value calculated out from an electronic file f and the hash value indicated in the certificate C.

(15b) A function to send a notice to a user terminal 40 when both hash values are not identical, then to return the certificate C to the user terminal.

(15c) A function to return the certificate C to an user terminal 40 if both hash values are noted to be identical.

Whereas, the document history management system 20 is provided with document history table 21, document history registering function 22 and certificate obtaining function 23. And, the functions 22 and 23 may be operated by installing a program for effectuating the respective functions from the storage medium.

The document history table 21 is a storage means, wherein labels, hash values, URL, date and ID are registered by the document history registering function 22, and from which the details of the registered information are read-out by the certificate obtaining function 23.

The document history registering function 22 has the following functions (22a) through (22c).

(22a) A function to number ID for an electronic file when the operation attribute of a XML document received from the document management system 10 is noted to be “New Registration”.

(22b) A function to register new registration labels, hash values, URL, date and ID into the document history table 21. Here, an electronic file registered hash values, ID, and so on into the document history table 21 is called “authorized file” or “original”.

(23c) A function to return the ID prepared in a XML document form to the document management system 10 following to completion of the registration.

The certificate obtaining function 23 has the following functions (23a) through (23d).

(23a) A function to search a historical information of an electronic file corresponding to ID from the document history table 13 when the operation attribute of a XML document received from the document management system 10 is “Issuing Authorized Original”, then to pick up the historical information corresponding to the ID.

(23b) A function to produce a XML document showing the history of an electronic file in a period from the new registration up to the latest revision.

(23c) A function to add a signature of the document history management system 20 onto the produced XML document.

(23d) A function to return the certificate containing the signature prepared in a XML document form to the document management system 10.

The certificate C is prepared in a form that the user can easily confirm a state that the electronic file is the authorized file owing to the certificate obtaining function 23. The certificate C is prepared in an easily-understandable form for the users, such as a XML document form, based on the hash value for a document for confirming no interpolated matter in said document and the historical information on the registration, the revision, etc. including the operation attribute, ID, date an so on in the document. Here, the information on date may be omitted or replaced with other information for indicating the temporal order. Further, as described later, time limitation may be included in the certificate C.

Besides, the authenticity of the document history itself may be assured by the other means, and there is no limitation for such means to assure the authenticity. Further, an arbitrary system may be used for a protocol at delivery of XML documents between the document management system 10 and the document history management system 20.

Whereas, the user terminal 40 has the following functions (40a) through (40c) in addition to commonly-known functions provided to a personal computer.

(40a) A function to register an electronic file f into the document management system 10 by user's operation at the time of new registration.

(40b) A function to designate the electronic file for confirming the original entity upon confirmation request for the original entity by user's operation, then send the confirmation request for the original entity to the document management system 10.

(40c) A function to receive a certificate C from the document management system 10 and to display it.

Now, the method of managing an electronic files according to the authorized original document management system as constituted above is explained separately by the respective operational phase. (At New registration)

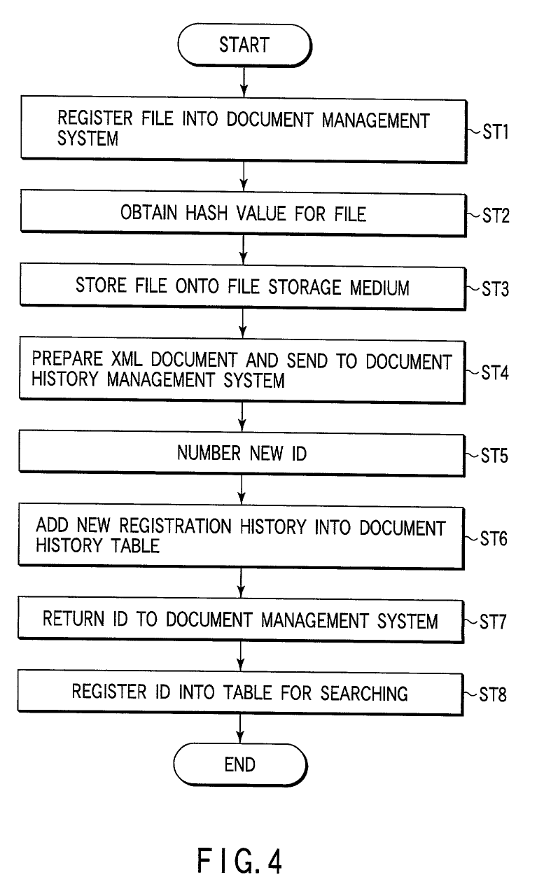

As shown in FIG. 4, the user terminal 40 registers an electronic file f into the document management system 10 by user's operation (ST1). The document management system 10 determines a hash value for the electronic file f by means of the hash value obtaining function 13 (ST2), then storing the electronic file f into the file storage medium 11 (ST3).

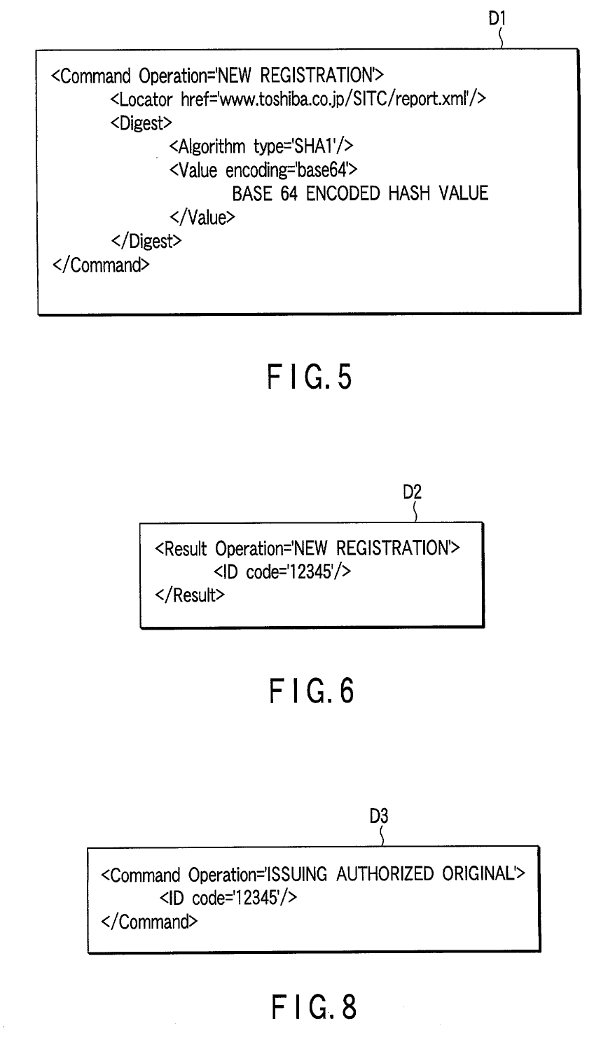

In addition, as shown in FIG. 5, the hash value obtaining function 13 produces a XML document D1 based on the hash value, information on other files (URL for the electronic file, etc.) and the operation attribute of “New Registration”, then sending the XML document D1 to the document history management system 20 (ST4).

The obtained hash value is a hash value itself, however, as shown in FIG. 5, it is preferable to further include additional information in the XML document, such as an algorithm, for example, SHAL (secure Hash standard-1) for determining a hash value and encoding system for hash values (base 64) in view of obtaining credibility of the hash value.

In the document history management system 20, the sent XML document D1 is received by the system 20, and when the operation attribute of the XML document D1 is “New Registration”, the document history registering function 22 in the system 20 numbers ID for an electronic file f (ST5), and new registration labels, hash values, URL, date and ID are simultaneously registered in the document history table 21 (ST6).

When the registration is completed, the document history management system 20 returns the XML document D2 containing ID to the document management system 10 (ST7), as shown in FIG. 6.

The document management system 10 records ID in the received XML document D2 into the table for search 12 (ST8).

(At Confirmation of Original Entity)

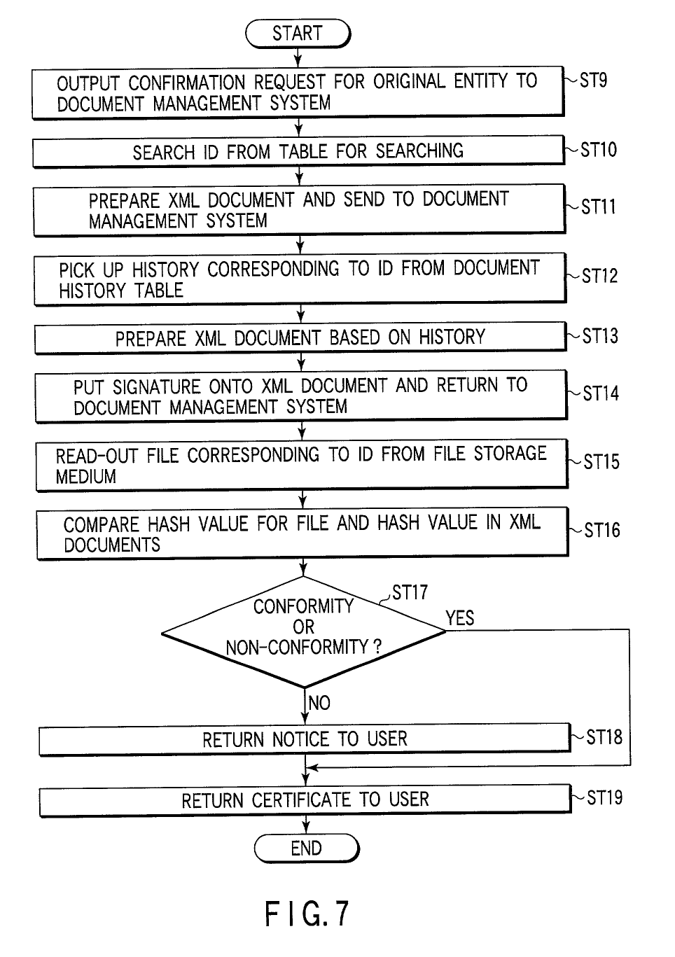

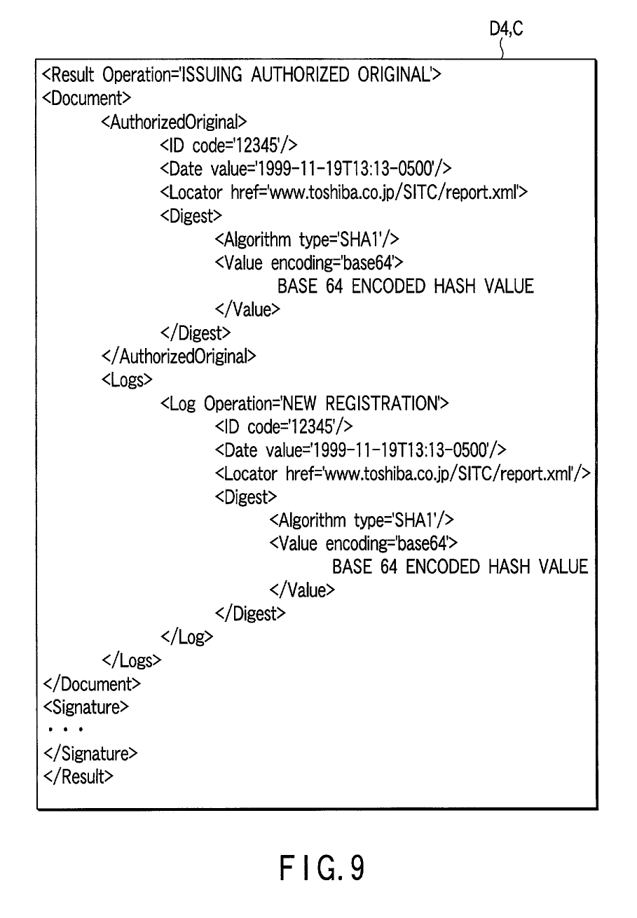

As shown in FIG. 7, the user terminal 40 designates the electronic file for confirming the original entity by user's operation and then send the confirmation request for the original entity to the document management system 10 (ST9). Here, the electronic file is retained in the document management system 10 or inputted from external.

The document management system 10 searches the designated electronic file f from the table for search 12 by employing the confirmation request processing function 14 upon confirmation request for the original entity (ST10) and then obtains ID for the designated electronic file. Then, the confirmation request processing function 14 produces a XML document D3 containing the operation attribute, “Issuing Authorized original”, by using the obtained ID, as shown in FIG. 8, and then send the XML document D3 to the document history management system 20 (ST11).

The document history management system 20 receives the sent XML document D3 and simultaneously searches the historical information from the document history table 21 based on the ID by employing the certificate obtaining function 23 when the operation attribute of the XML document D3 is “Issuing Authorized Original”, and then picks up the historical information corresponding to the ID (ST12).

Then, the certificate obtaining function 23 produces a XML document indicating history for a period of from the new registration up to the latest revision based on the obtained historical information (ST13), then adding the signature of the document history management system onto the XML document, and returns the certificate consisting of the ultimately-obtained XML document D4 to the document management system 10 (ST14). The signature described above is conformable to a standard form.

The document management system 10 reads out the electronic file f corresponding to the ID indicated in the certificate C by employing the hash value comparing function 15 from the file storage medium 11 upon receipt of the certificate C (ST15), compares the both hash values calculated out of the electronic file f and in the certificate C (ST16), thereby determining the conformity of both hash values (ST17).

The hash value comparing function 15 informs a notice to the user terminal 40 (ST18) when both hash values are not identical (ST18) and then returns the certificate C to the user terminal 40 (ST19), while proceeding to the step ST19 to return the certificate C to the user terminal 40 when both of the hash values are identical.

The user terminal 40 displays the returned certificate C and allows the user to confirm the original entity of the electronic file f. For example, the user terminal 40 can displays a form being converted to the hrml (Hyper Text Markup Language) document form of the certificate C by using XSLT processor when using Web browser corresponding to XML.

As described above, according to the present embodiment, the system issues an certificate describing that the electronic file f is not interpolated (=hash value) and that the electronic file is the latest revision (document history (log) information) upon confirmation request for the original entity of the electronic file f and outputs the issued certificate, and therefore, the users can easily confirm the original entity of the electronic file.

Further, the certificate C is prepared such form that the hash value and the historical information can be visibly confirmed by the users as a XML document D4, and therefore, the users can easily confirm the original entity of the electronic file.

More particularly, the interface in the document management system 40 is opened in a XML document form so that the users can easily understand the process details at authorizing the original entity.

Further, in addition to the system to return an certificate C for authorizing the original entity of an electronic file f, the requirement of authorizing original entity is shared by the document management system 10 and the document history management system 20, and only requirements important for authorizing original entity, such as prevention of interpolation and document history management, is assured by the document history management system 20. From this reason, the authorized original document management system of the present invention can be constituted by slightly altering the conventional document management system, such as providing an additional function of electronic signing function, and newly connecting the document history management system 20 thereto.

(Second Embodiment)

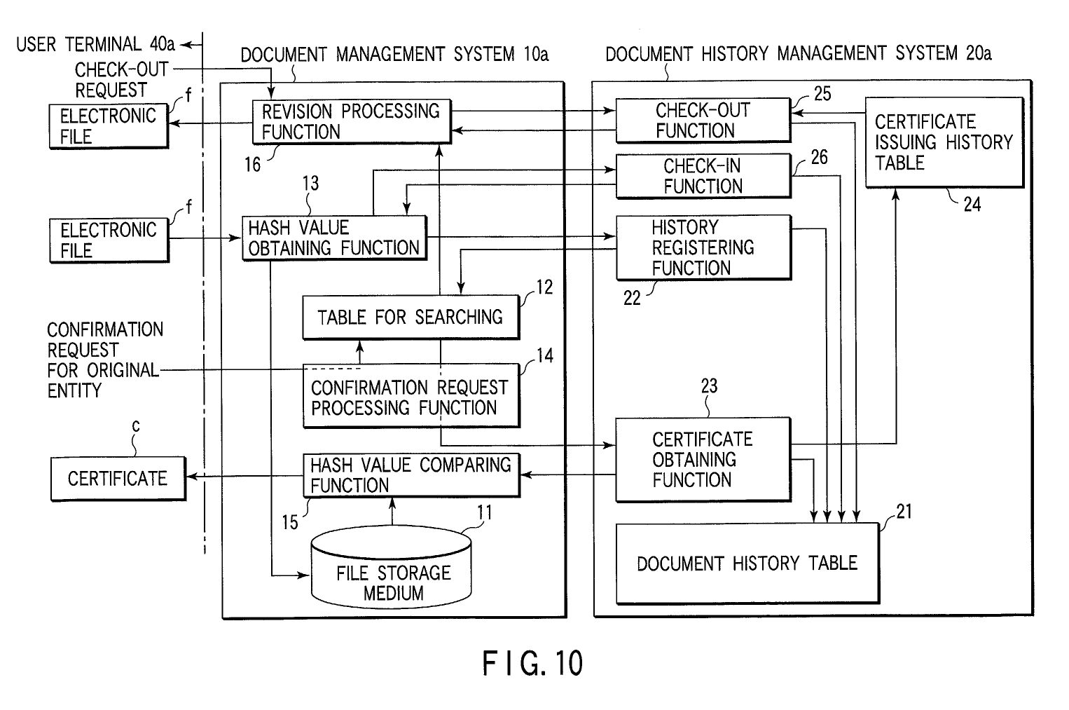

FIG. 10 is a block diagram showing the constitution of the authorized original document management system according to the second embodiment, wherein the same symbol numbers are provided for the same parts as the ones described above for allowing to delete the overlapped explanation. Therefore, only the different parts will be described in the following.

The present embodiment is directed to the authorized original document management system described for the first embodiment, wherein a check-out function for releasing the revision (modification and renewal) restricting state of an electronic file f and a check-in function for recovering the electronic file f into the revision restricting state are further added to the system described in the first embodiment.

Because of such addition, the user terminal 40 has also the following functions (40d) and (40e) in addition to the above described functions (40a) through (40c).

(40d) A function to designate an electronic file f to be revised by user's operation and to send a check-out request to the document management system 10a.

(40e) A function to register the revised electronic file f into the document management system 10a.

The document management system 10a described above is provided with revision processing function 16 in addition to the functions described above. The revision processing function 16 is prepared so as to be workable by installing a program to effectuate its function from the storage medium.

More definitely, the revision processing function 16 has the following functions (16a) through (16e).

(16a) A unction to search the table for search 12 based on the designated electronic file f upon a check-out request from the user terminal 40a and to obtain ID for the electronic file f from the table for search 12.

(16b) A function to produce a XML document containing the operation attribute “check-out” by using the obtained ID and to transmit the XML document to the document history management system 20a.

(16c) A function to examine URL by employing the table for search 12 based on the picked-up ID from the XML document when the XML document returned from the document history management system 20a is not an error message.

(16d) A function to read-out the electronic file f corresponding to the ID from the file storage medium 11 based on the examined URL and to transmit the obtained electronic file f to the user terminal 40a.

(16e) A function to return the error message to the user terminal 40a when the returned XML document from the document history management system 20a is an error message.

Whereas, for the document history management system 20a, in addition to the functions described above, certificate issuing history table 24, check-out function 25 and check-in function 26 are additionally provided. However, the functions 25 and 26 are provided so as to be workable by installing a program to effectuate each of those functions from the storage medium.

The certificate issuing history table 24 is to render the original electronic file f to be renewal-restricted state during the time limitation for the certificate C, and definitely, the latest ID, issuing date and time limitation are registered in said table 24.

The check-out function 25 is to perform check-out process which releases the revision-restricted state of the electronic file f and transits it to the revisable state prior to the revision of the electronic file f. However, the check-out function 25 has a function not to perform the check-out process when the electronic file f has already been processed for the check-out and being revisable state and when the original certificate is still within the time limitation.

More definitely, the check-out function 25 has the following functions (25a) through (25g).

(25a) A function to examine the latest ID for the electronic file f corresponding to the ID from the document history table 21 when the operation attribute for a XML document received from the document management system 10a is “check-out” and to pick up the history retained in the document history table 21 corresponding to said latest ID.

(25b) A function to determine if the operation attribute for the electronic file f is “check-out” or not based on the document history details corresponding to the latest ID.

(25c) A function to produce a XML document containing the error message when the operation attribute for the electronic file f is “check-out”.

(25d) A function to examine if the certificate corresponding to the latest ID is within the time limitation or not by employing the certificate issuing history table 24 when the operation attribute for the electronic file f is not “check-out”, and to produce a XML document containing the error message when the electronic file f is within the time limitation.

(25e) A function to number an ID for the history as to the check-out when the operation attribute for the electronic file f is not “check-out” and the electronic file f is out of the time limitation, namely, when check-out processing is positive, and to register the label indicating the check-out, ID, date and the latest ID before the check-out in the history.

(25f) A function to produce a XML document based on the numbered ID, the latest ID before the check-out, URL and the hash value.

(25g) A function to return either the produced XML document or the XML document containing the error message described above to the document management system 10a.

The check-in function 26 is to perform the check-in process to renew and register the revised electronic file f when the revision of the electronic file f, which has been processed for the check-out owing to the check-out function 25, is completed. Provided, the check-in process is workable only when the electronic file f has already been processed for the check-out.

More definitely, the check-in function 26 has the following functions (26a) through (26g).

(26a) A function to verify the document history table 21 when the operation attribute of the XML document transmitted from the document management system 10a is “check-in”.

(26b) A function to produce the error message as a XML document when it is noted that the electronic file f corresponding to the ID has not currently been subjected to “check-out” process as a result of verification of the document history table 21.

(26c) A function to number a mew ID when the verification result of the document history table 21 indicates as being processed for the “check-out”.

(26d) A function to register the label indicating the check-in, ID, date, URL, hash value, etc. in the document history and to produce a XML document based on the numbered ID.

(26e) A function to return the produced latest XML document indicating the original entity or a XML document containing the error message to the document management system 10a.

Now, the method of managing the electronic files according to the authorized original document management system as constituted above is explained separately by each operations, however, the method at the time of new registration is omitted since the procedure at new registration is same as one described above.

(At Check-Out Process)

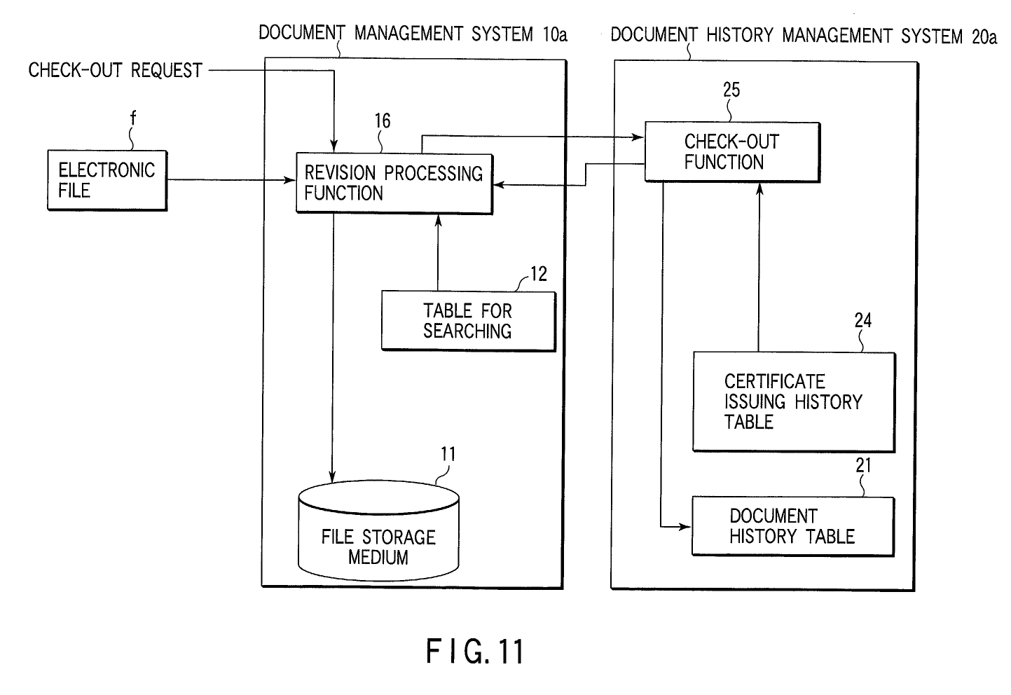

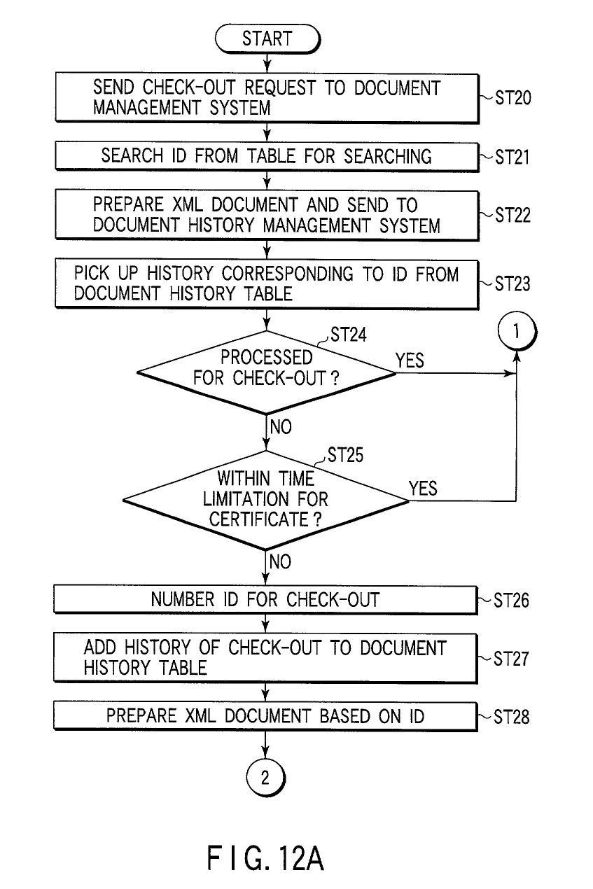

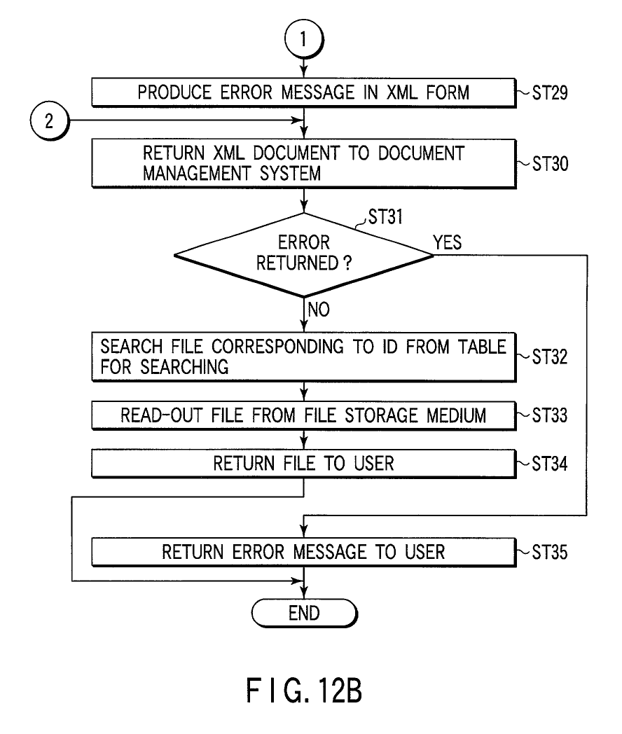

As shown in FIGS. 11, 12A and 12B, the user terminal 40a designates the electronic file f for the revision by the user's operation and sends a check-out request to the document management system 10a (ST20).

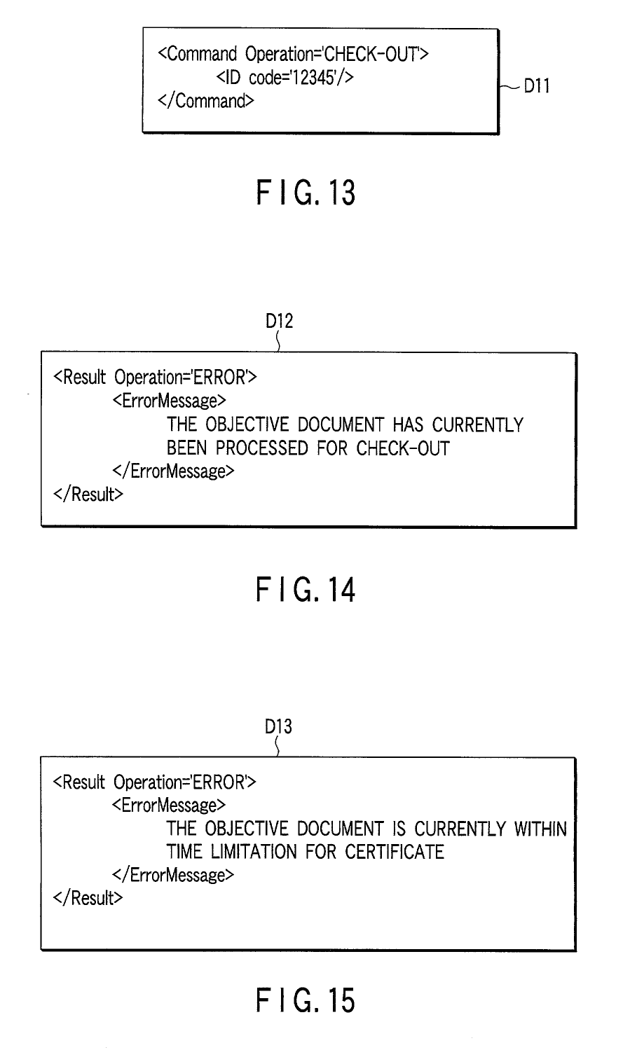

In the document management system 10a, the revision processing function 16 searches the table for search 12 for the designated electronic file f upon check-out request (ST21) and obtains ID for the designated electronic file f. Then, as shown in FIG. 13, the revision processing function 16 produces a XML document D11 containing the operation attribute “check-out” by using the ID and sends the XML document D11 to the document history management system 20a (ST22).

When the document history management system 20a received the sent XML document D1, the check-out function 25 examines the latest ID for the electronic file f corresponding to the ID in the document history table 21 when the operation attribute for the XML document is “check-out” and pick up the historical information retained in the document history table 21 (ST23). This is because of a need to revise the electronic file f having the latest ID, since new ID is given to the electronic file f at every occasions of check-out and check-in processing.

Then, the check-out function 25 determines if the electronic file f has been already processed for the check-out or not based on the historical details of the electronic file f corresponding to the latest ID (ST24) and proceeds to ST 29 to produce a XML document D12 containing the error message as shown in FIG. 14 when the electronic file f has been processed for the checkout. On the other hand, when the file f has not been processed for the check-out, the check-out function 25 examines if the file f is within the time limitation for the certificate C corresponding to the latest ID or not (ST25).

When it is found as “within the time limitation” from the result of the examination at the step ST25, the electronic file f cannot be processed for the check-out, and the check-out function 25 proceeds to the step ST29 and produces the XML document containing the error message as shown in FIG. 15.

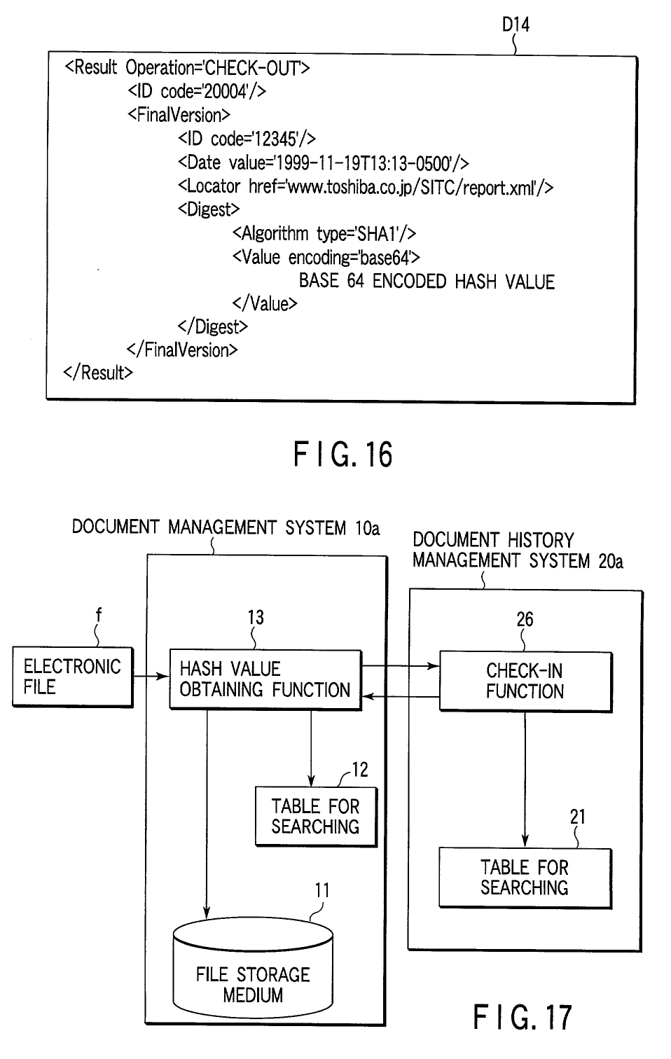

On the other hand, when the electronic file f can be processed for the check-out, the check-out function 25 numbers ID for the history as to the check-out (ST26). The check-out function 25 registers the label indicating the check-out, ID, date, and the latest ID before the check-out in the document history table 21 (ST27) and produces a XML document D14 containing the numbered ID, the latest ID before the check-out, URL and the hash value (SY28), as shown in FIG. 16. The URL and the hash value are to designate the electronic file f for the renewal and to check the content of the electronic file f.

The check-out function 25 also returns either the XML document indicating the original entity of the latest XML document D14 produced in the step ST28 or the XML document D12 (or D13) indicating the error message produced in the step 29 to the document management system lOa (ST30).

Then, the document management system 10a examines if the returned XML document D14 is an error message or not (ST31), and proceeds to the step ST35 to return the error message to the user terminal 40a when the XML document D14 is an error message, then ending the processing.

Contrary, when the XML document D14 is determined as no error message at the step ST31, the document management system 10a examines the table for search 12 based on the ID picked up from the XML document D14 (ST32), reads-out the electronic file f corresponding to the ID from the file storage medium 11, and sends the obtained electronic file f to the user terminal 40a (ST34).

(At Check-In Process)

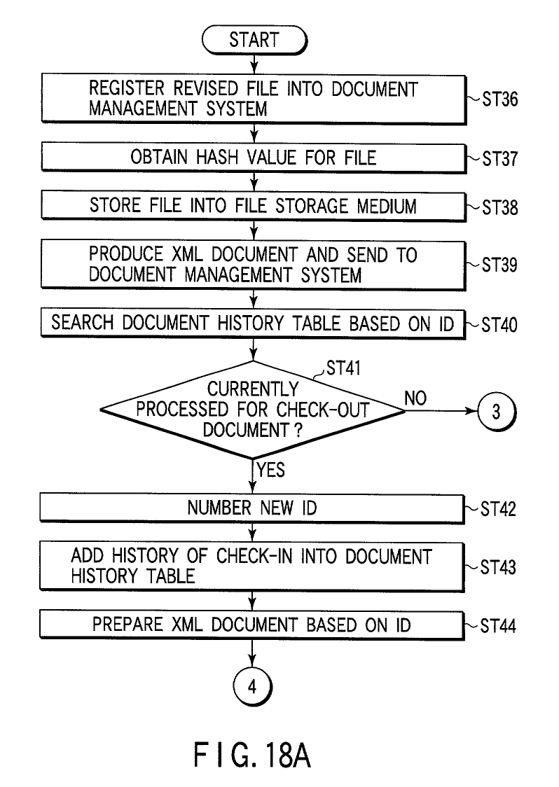

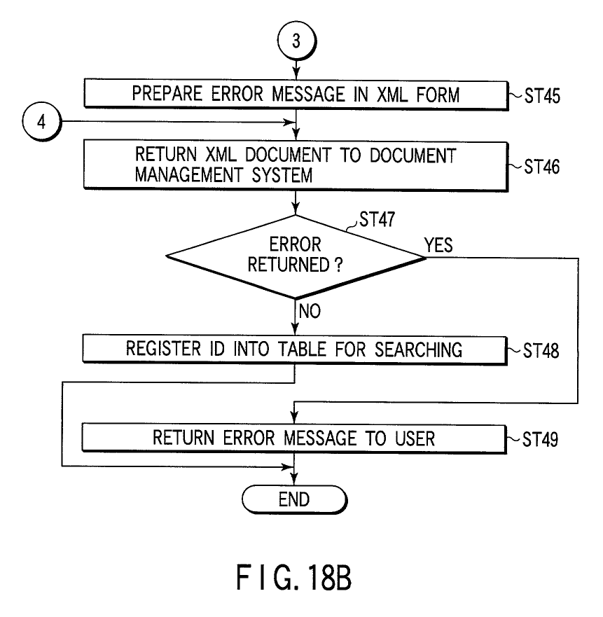

As shown in FIGS. 17, 18A and 18B, the user terminal 40a registers the revised electronic file f in the document management system 10a (ST36) by user's operation.

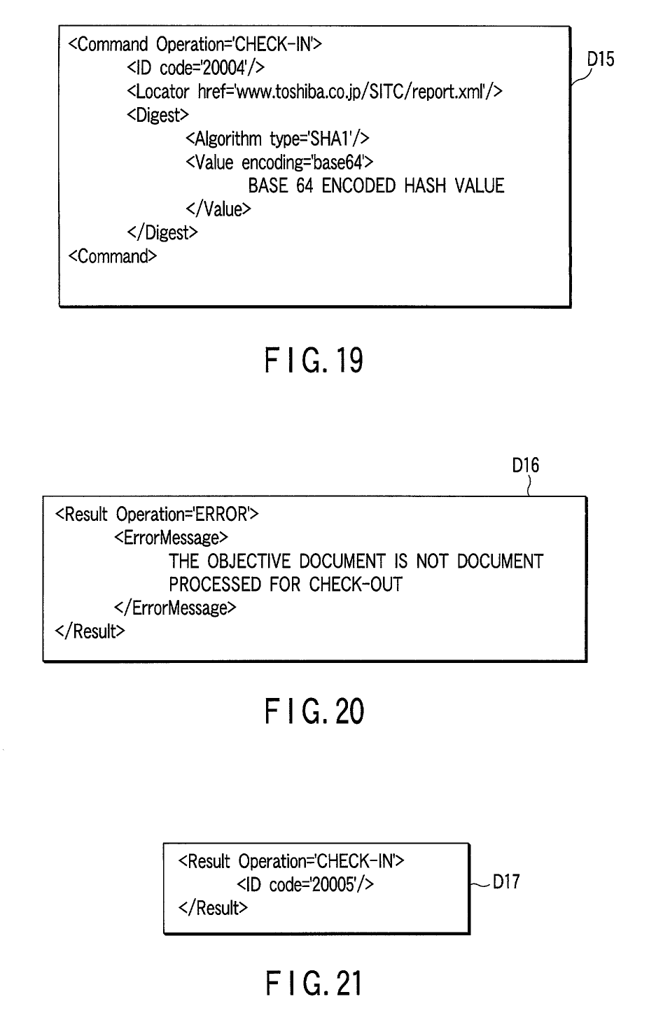

In the document management system 10a, the hash value for the revised electronic file f is determined by the hash value obtaining function 13, and the electronic file f is then stored in the file storage medium 11 (ST38). Then, the document management system 10a produces a XML document D15 as shown in FIG. 19 based on the numbered ID, URL and the hash value at the check-out process in the document history management system 20a, and sends the XML document D15 to the document history management system 20a (ST39).

When the document history management system 20a received the sent XML document D15 and the operation attribute of the XML document D15 is “Check-in”, the document history management system 20a examines the document history table 21 by employing the check-in function 26 (ST40) and confirms that the electronic file f corresponding to the ID has currently been processed for the check-out (ST41). If the file f has not been processed for the check-out, the system proceeds to the step ST45 and produces an error message as a XML document D16 as shown in FIG. 20.

Contrary, when the result of the step ST40 is “Processed for Check-out”, the check-in function 26 newly numbers an ID (ST42), registers the label indicating check-in, ID, date, hash value, etc. in the document history table (ST43) and produces a XML document D17 as shown in FIG. 21 based on the numbered ID (ST44).

The XML document D17 for indicating the latest ID for the original document produced in the step 44 or the XML document D16 produced in the step 45 for indicating the error message are returned to the document management system 10a by the check-in function 26.

The document management system 10a examines if the returned XML document D17 is indicating the error message or not (ST47), and when it is for the error message, the system 10a proceeds to the step 49 to return the error message to the user terminal 40a and ends the processing.

Contrary, when it is noted that the returned XML document is not for the error message, the document management system 10a picks up the numbered ID from the XML document D17 and registers the ID together with the file information into the table for search 11 (ST48).

(At Original Entity Confirmation Process)

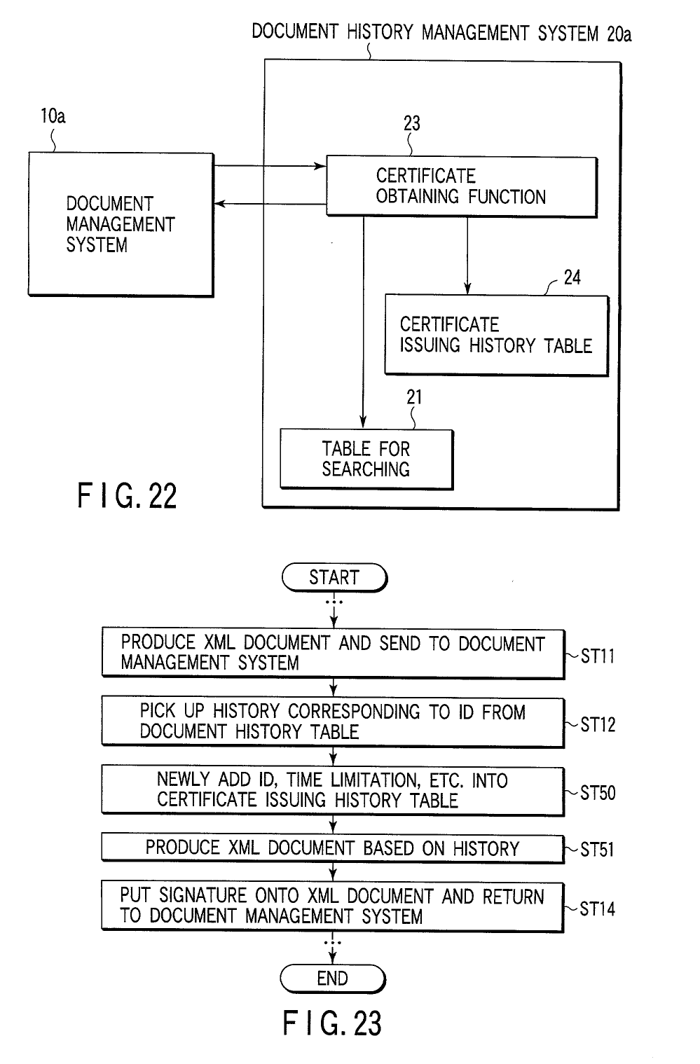

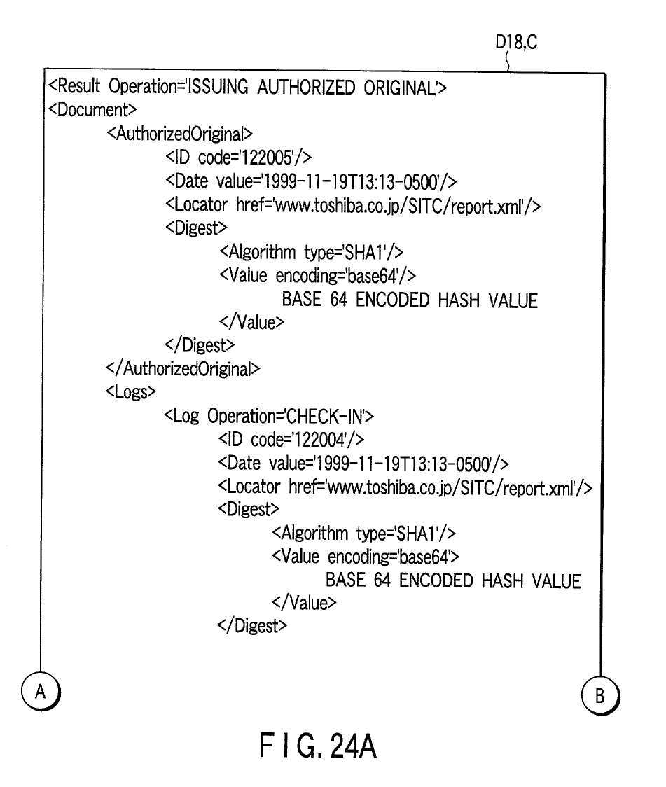

As shown in FIGS. 22 and 23, and according to the same procedures described in the first embodiment, the document management system 10a produces a XML document containing ID and send it to the document history management system 20a (ST11).

The document history management system 20a receives the XML document from the document management system 10a, then searches the document history table 21 based on the ID in the XML document by employing the certificate obtaining function 23, and obtains all historical information as to the ID during the a period of from the new registration up to the latest check-in in an array pattern (ST12).

Further, the certificate obtaining function 23 registers the latest ID, issuing date and time limitation into the certificate issuing history table 23 (ST50).

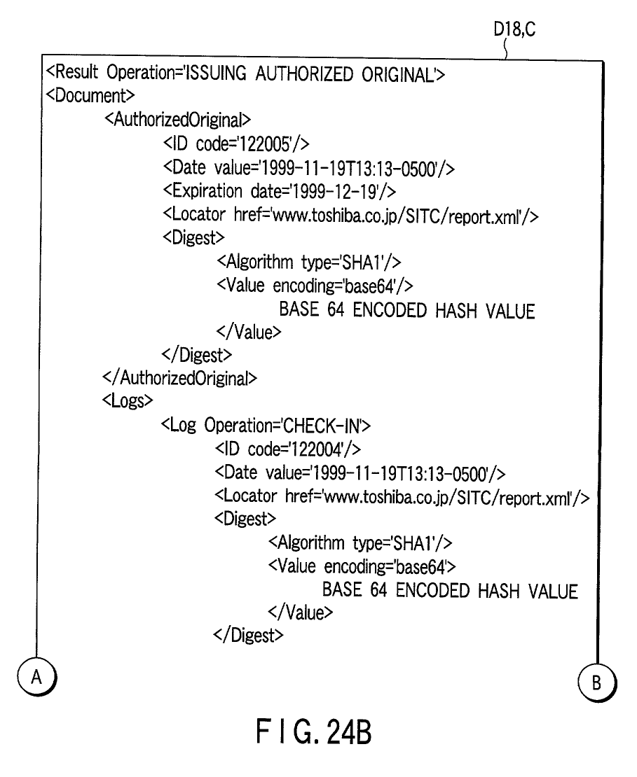

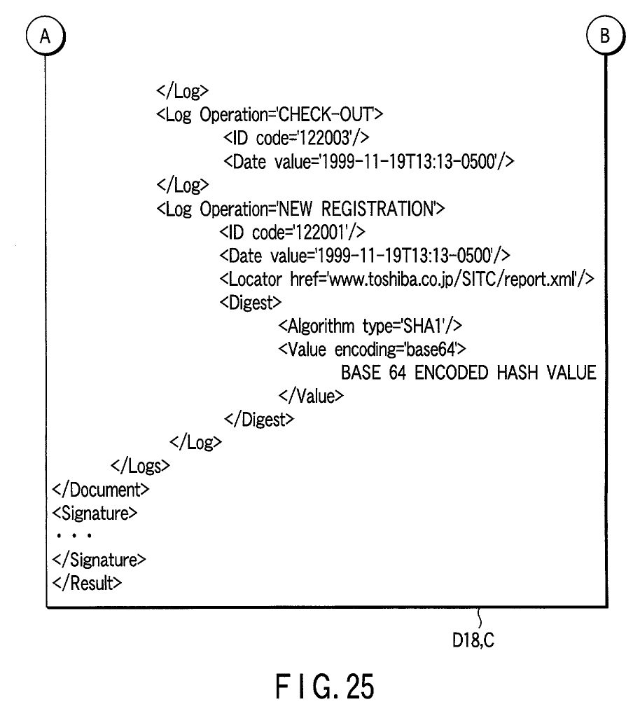

Further, the certificate obtaining function 23 produces a XML document based on the obtained historical information (ST51), adding a signature of the document history management system 20a onto the XML document, and return the ultimately-obtained XML document D18 as an certificate C to the document management system 10a (ST14) as shown in FIGS. 24A and 25 or FIGS. 24B and 25.

In the returned certificate (=XML document D18), which is different from the certificate described in the first embodiment, <Log> tag is additionally provided, and history as regard to check-in and checkout is described in operational order and in time series order. Besides, the history may be described in time series order from an old particular. Further, the certificate C may include no time limitation as shown in FIGS. 24A and 25, or it may include the time limitation as shown in FIGS. 24B and 25.

The following steps for the operation in the system according to the second embodiment are same as the steps from the step 15 onward in FIG. 7 described above.

As described above, according to the present embodiment, an electronic file f can be revised while assuring the original entity of the electronic file f owing to adding the check-out function 25 for releasing the electronic file f being in revision (plus amendment and renewal) restricted state and the check-in function 26 for recovering the electronic file f to revision restricted state in addition to the functions given for the system according to the first embodiment.

Further, the check-out function 25 refers the certificate issuing history table 24 to thereby determine if the objective file is within the time limitation or not upon receipt of ID from the document management system and restricts to execute the checkout process when the file is within the time limitation, thereby allowing to easily assure the conformity between the original document and the certificate.

Besides, the embodiments described above are directed to the document history management system 20 and 20a for performing document interpolation prevention and history management in the document management system 10 and 10a having authorizing original function, however, the document history management system 20 or 20a itself can be applied for other systems than the document management system 10 and 10a.

For example, the document history management system 20 or 20a itself is applicable for interpolation prevention of resources and version management in Web server and interpolation prevention of application forms and version management in electronic application systems. Further, the system can flexibly comply with user's needs by combining necessary systems depending upon an application.

Although information exchange between the document management system 10 or 10a and the document history management system 20 or 20a is executed by the exchange of XML documents in the first and the second embodiments described above, for at least an certificate containing necessary information, such as ID and hash value, the constitution of the authorized original document management system can be modified to the one using a document other than XML document. However, the use of a XML document for the certificate is preferable in view of a point that the user terminal 1 that received the certificate can display the certificate on Web browser adapted to XML and that no special application is required for displaying the certificate.

In both embodiments described above, the functions required for the document management system 20 or 20a and the information exchange manner are defined, however, any embodiment provided with any other manner for performing such functions 22, 23, 25 and 26 and/or the document forms for the document history table 21 and the certificate issuing history table 24, which accord to the definition described above, falls within the scope of the present invention.

As the storage medium used in the present invention, any type of medium can be used if it is one capable of storing a program and reading by a computer, such as magnetic disk, floppy disk, hard disk, optical disk including CD-ROM, CD-R, DVD, etc., magnet-optical disk like MO and semiconductor memory.

Further, OS (Operating program) working on a computer in accordance with instruction of a program installed from a storage medium into a computer and MW (Middle ware), such as database management software and network software, may be used as a part of the process for performing the embodiment according to the present invention.

In the storage medium to be used in the present invention, not only a medium independent from a computer but also a storage medium for downloading a program transmitted by LAN, Internet or the like and storing or temporarily storing the program can be included.

And, the number of the storage medium is not limited to one, and a case using plural media for executing the process in the above embodiments is also included in the storage medium specified in the present invention, and any medium constitutions may be applied in the embodiments described above.

Besides, the computer specified in the present invention is defined as a computer executing respective processes in the embodiments described above in accordance with the programs stored in the storage medium, and either constitution of one constituted with single personal computer, etc. or a system wherein plural apparatus are connected in network may be used.

In the computer defined in the present invention, not only a personal computer but also an operational processor included in information processing apparatus, micon, etc. may be included, and it generally includes apparatus and systems capable of performing the functions specified in the present invention with programs.

The present invention should not be limited to the description in the embodiments described above, and the embodiments can be modified in various manners as far as it is within a scope not exceeding the subject matter of the present invention at the practical operating stage. Further, each embodiment may be combined to carry out the invention, if appropriate, and in that case, a combined effect may be further expected. Moreover, as various inventions are contained at the various stages in the embodiments described above, several inventions may be extracted from the above description by appropriately combining the plural constitutions disclosed above. For example, if an invention is extracted by deleting some constitutions from the whole constitutions disclosed in the embodiment, the deleted constitutions may be appropriately supplemented by publicly known conventional arts when carrying out the extracted invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method of managing an electronic file, comprising:
a step of issuing a certificate that the electronic file is not interpolated and that the electronic file is the latest upon request for verifying the electronic file is authorized file; and
a step of outputting the issued certificate.

2. The method according to claim 1, wherein the certificate includes operational history for an electronic file corresponding to the request for verifying.

3. The method according to claim 1, wherein description of that the electronic file is not interpolated is expressed by description of a summarized value for the electronic file.

4. The method according to claim 1, wherein the certificate includes a summarized value for the electronic file and operational history for the electronic file.

5. The method according to claim 1, further comprising:
a step of determining if the renewal request for the electronic file is within the time limitation for the issued certificate or not upon input of writing-in request for renewal processing for the electronic file, and
a step of restricting the renewal processing when the renewal request is within the time limitation.

6. A method of managing an electronic file, comprising:
a step of producing the first information to indicate that the electronic file is not interpolated upon request for verifying the electronic file is authorized file;
the second information to indicate that the electronic file is the latest;
the third information to indicate the time limitation for the first and second information;
a step of outputting the produced first to third information; and
a step of determining if the renewal request is within the time limitation for the first and second information upon input of the blowing request for renewal processing of the electronic file and restricting an execution of the renewal processing when the result of the determination indicates within the time limitation.

7. A method of managing an electronic file for authorizing the electronic file is authorized file by utilizing document management system for managing electronic files and document history management system connected to the document management system for managing the history for the electronic files, comprising:
a step of obtaining a summarized value for an input electronic file upon input of the electronic file for authorizing the electronic file is authorized file into the document management system and retaining the obtained summarized value in the document history management system;
a step of retaining the input electronic file in the document management system;
a step of determining conformity or non-conformity between the summarized value newly obtained from the electronic file being retained in the document management system or the electronic file inputted from external and the corresponding summarized value in the document history management system; and
a step of authorizing the electronic file is authorized file when the result of the determination indicates the conformity of the two summarized values.

8. The method according to claim 7, wherein the step of authorizing the electronic file is authorized file includes a step of issuing a certificate for authorizing that the electronic file is the authorized file.

9. The method according to claim 8, wherein
the system comprises check-out step for simultaneously renewing the electronic file and the summarized value corresponding to the electronic file;
check-in step of retaining the revised electronic file in the document management system while retaining the summarized value for the revised electronic file when the revised edition of the electronic file is prepared following to the check-out step;
a step of determining conformity or non-conformity between the newly obtained summarized value from the revised electronic file in the document management system and the summarized value in the document history management system corresponding to the revised electronic file upon input of request for verifying the electronic file is authorized file following to the check-in step; and
a step of authorizing the revised electronic file is authorized file when the result in the determination indicates the conformity of the two summarized values.

10. The method according to claim 8, wherein
the step of retaining the summarized value in the document history management system:
includes a step of retaining a label for new registration, the summarized value and ID for the electronic file upon receipt of the summarized value from the document management system and to return the ID to the document management system;
the step of authorizing the electronic file is authorized file comprises:
a step of outputting a certificate containing the summarized value corresponding to the ID and the operational history for the electronic file corresponding to the ID upon receipt of the ID from the document history management system.

11. The method according to claim 9, wherein the check-out step comprises:
a step of registering a label for check-out and new ID for the check-out upon receipt of ID for the electronic file being objective for the check-out from the document management system and returning the new ID to the document management system;
the check-in step comprises:
a step of registering a label for check-in, a summarized value and new ID for the check-in upon receipt of ID for the check-in and the summarized value for the revised electronic file and returning the new ID for the check-in to the document management system.

12. The method according to claim 11, wherein the check-out step comprises:
a step of determining if the electronic file is within the time limitation for the issued certificate or not when receiving the ID from the document management system and a step of restricting the execution of the check-out processing when the electronic file is within the time limitation.

13. The method according to claim 10, wherein
the receipt of the ID or the summarized value includes; a step of receiving a document data prepared according to a fixed form using a standard markup language and by containing the ID and the certificate, and
the return of the ID or the certificate includes;
a step of producing the document data prepared according to a fixed form using a standard markup language and by containing the ID or the certificate and to return the document data.

14. A computer program product stored on a computer-readable medium for use in an electronic file management system, the program product comprising;
first program code that issues a certificate that the electronic file is not interpolated and that the electronic file is the latest upon input of request for verifying the electronic file is authorized file; and
second program code that outputs the issued certificate.

15. The computer program product according to claim 14, wherein
the certificate includes the operational history for the electronic file corresponding to the request for verifying.

16. The computer program product according to claim 14, wherein
the description of that the electronic file is not interpolated is expressed by the description of the summarized value for the electronic file.

17. The computer program product according to claim 14, wherein
the certificate includes the summarized value for the corresponding electronic file and the operational history for the corresponding electronic file.

18. The computer program product according to claim 14, wherein the program code further comprising;
third program code that determines if blowing request for the renewal processing of the electronic file is within the time limitation for the issued certificate upon input of the blowing request or not; and
forth program code that restricts the renewal processing when the request is within the time limitation.

19. A computer program product stored on a computer-readable medium for use in an electronic file management system, the program product comprising;
first program code that produces the first information indicating that the electronic file is not interpolated, the second information indicating that the electronic file is the latest and the third information indicating the time limitation for the first and second information upon request for verifying the electronic file is authorized file,
second program code that outputs the produced first to third information, and
third program code that determines based on the third information if a blowing request for renewal processing of the electronic file is within the time limitation for the first and second information or not and then to restrict the execution of the renewal processing when the result of the determination indicates that the request is within the time limitation.

20. A computer program product stored on a computer-readable medium for use in an electronic file management system for authorizing the electronic file is authorized by utilizing document management system for managing electronic files and document history management system connected to the document management system for managing the history for the electronic files, the program product comprising;
first program code that sends ID for an electronic file corresponding to request for verifying the electronic file is authorized file from the document management system to the document history management system upon input of request for verifying into the document management system;
second program code that returns a summarized value corresponding to the ID received from the document management system together with the ID among the summarized values and ID for electronic files registered in the document history management system from the document history management system to the document management system; and
third program code that outputs a certificate for authorizing the electronic file is authorized file corresponding to the ID.

21. The computer program product according to claim 20, wherein the program product further comprising;
fourth program code that sends ID for the electronic file and a label for check-out from the document management system to the document history management system upon input of check-out request for the electronic file into the document management system;
fifth program code that returns new ID corresponding to the check-out from the document history management system to the document management system upon receipt of ID and the label for the check-out;
sixth program code that sends a summarized value for the revised electronic file, ID and the label for check-in from the document management system to the document history management system upon input of the revised electronic file into the document management system;
seventh program code that returns new ID corresponding to the check-in from the document history management system to the document management system upon receipt of the summarized value for the revised electronic file, the ID and the label for the check-in,
eighth program code that sends ID for the revised electronic file from the document management system to the document history management system upon input of request for verifying the revised electronic file into the document management system;
ninth program code that returns a summarized value corresponding to the ID for the revised electronic file received from the document management system together with the ID from the document history management system to the document management system; and
tenth program code that outputs a certificate for authorizing the revised file is authorized file corresponding to the ID based on the ID and the summarized value returned from the document history management system.

22. The computer program product according to claim 20, wherein the certificate includes at least the ID, the summarized value and the operational history for the electronic file corresponding to the ID.

23. The computer program product according to claim 22, wherein sending from the document management system to the document history management system and returning from the document management system to the document history management system are executed by communication with a document data prepared in accordance with respective fixed forms using a standard markup language and by containing at least ID and a summarized value.

24. A computer program product stored on a computer-readable medium for use in a document management system for managing electronic files connected to a document history management system for managing the history of electronic files, the program product comprising;
first program code that sends ID for the electronic file corresponding to request for verifying to the document history management system upon input of the request for verifying the electronic file is authorized file;
second program code that outputs an certificate for authorizing the electronic file is authorized file corresponding to the ID based on the ID and the summarized value returned from the document history management system corresponding to the request for verifying among the summarized values and the ID for the electronic files registered in the document history management system.

25. A computer program product stored on a computer-readable medium for use in a document history management system for managing the history of an electronic file being connected to a document management system for managing electronic files, the program product comprising;
program code that sends a summarized value for the electronic file corresponding to ID received from the document management system from the document history management system to the document management system together with the ID upon request for verifying the electronic file is authorized file, and
wherein the summarized value and the ID are used for the preparation of the certificate for authorizing the electronic file is authorized file corresponding to the ID.
